(19) United States
(12) Patent Application Publication
(10) Pub. No.: US 2016/0376013 A1
(43) Pub. Date: Dec. 29, 2016

(54) SANITARY MODULE COMPRISING A FOLDING ALCOVE FOR AN AIRCRAFT AND AIRCRAFT DOOR REGION

(71) Applicant: Airbus Operations GmbH, Hamburg (DE)

(72) Inventor: Johannes Gonnsen, Hamburg (DE)

(21) Appl. No.: 15/193,250

(22) Filed: Jun. 27, 2016

(30) Foreign Application Priority Data
Jun. 25, 2015 (DE) 102015211813.4

(51) Int. Cl. B64D 25/00; B64D 11/02

(52) U.S. Cl. CPC B64D 25/00; B64D 11/02; B64D 2011/0046

(57) ABSTRACT

A sanitary module comprising a folding alcove for an aircraft. The module comprises a side wall forming a stationary vertical portion of an outer wall. An alcove wall forms a movable vertical portion of the outer wall and is movable into an inner space of the module. Two folding connections each connect a vertical edge of the alcove wall to a vertical edge of the side wall and form the folding alcove with the alcove wall. The folding connections can be folded out into the inner space to move the alcove wall into the inner space to create a folded-out state of the folding alcove such that an alcove is formed in the outer wall of the module. The folding connections can be folded in to create a folded-in state of the folding alcove such that the alcove wall is in contact with the side wall.

### CROSS-REFERENCES TO RELATED APPLICATIONS

This application claims the benefit of the German patent application No. 10 2015 211 813.4 filed on Jun. 25, 2015, the entire disclosures of which are incorporated herein by way of reference.

### FIELD OF THE INVENTION

The present invention relates to a sanitary module comprising a folding alcove for an aircraft and to an aircraft door region comprising a sanitary module of this type.

### BACKGROUND OF THE INVENTION

In some situations, it is necessary for the aircrew of an aircraft to be available to the passengers at the aircraft door so that they can help them exit or enter. In addition to the systematic entry and exit, this can be required, for example, in the event of emergencies as a result of safety regulations. In this case, the aircrew can oversee the evacuation of the aircraft and help passengers with any problems when exiting the aircraft. For this purpose, the aircrew usually stands inside the aircraft directly in the region of the aircraft door. In many cases, specifically for this purpose, a special region is provided in the interior of the aircraft which is also referred to as an “assist space” or “assistance space.”

An assist space of this type can be produced in various ways. To the side of the entry region of an aircraft, there are often various fixtures which are provided for use by the crew or the passengers of the aircraft. Such fixtures are also referred to as monuments and comprise, in particular, sanitary modules (e.g., toilets) and galleys. A solution can accordingly comprise providing an assist space in or on such a monument. DE 10 2011 109 390 A1, DE 10 2011 116 523 A1 and DE 10 2011 013 049 A1 thus describe different possibilities for accommodating an assist space in the region of an entry door. In these cases, either a recess is provided in one of the monuments or a specific region in the arrangement of the monuments is taken out and made available to the aircrew.

### SUMMARY OF THE INVENTION

In view of the above, an idea of the present invention is that of identifying solutions for creating additional space in the region of an aircraft door which can be configured flexibly and on short notice according to the flight situation in each case.

Accordingly, a sanitary module comprising a folding alcove for an aircraft is provided. The sanitary module comprises a side wall which forms a stationary vertical portion of an outer wall of the sanitary module. The sanitary module further comprises an alcove wall which forms a movable vertical portion of the outer wall of the sanitary module and can be moved into an inner space of the sanitary module. The sanitary module further comprises two folding connections, which each connect a vertical longitudinal edge of the cubicle wall to a vertical longitudinal edge of the side wall and form the folding alcove together with the alcove wall. The folding connections can be folded out into the inner space of the sanitary space so that the alcove wall can be moved into the inner space of the sanitary module to create a folded-out state of the folding alcove in such a way that an alcove is formed in the outer wall of the sanitary module by the alcove wall and the folding connections. The folding connections can be folded in to create a folded-in state of the folding alcove in such a way that the alcove wall is in contact with the side wall.

Furthermore, an aircraft door region is provided. The aircraft door region comprises a first aircraft door, a first entry region which is adjacent to the first aircraft door, and a sanitary module according to the invention, the outer wall of which is adjacent to the first entry region. The folding alcove of the sanitary module is formed in a portion of the outer wall of the sanitary module which faces the first entry region.

Furthermore, an aircraft comprising an aircraft door region according to the invention is provided.

The concept on which the present invention is based comprises providing a means with which an assist space can be created quickly and simply in specific flight situations without losing the corresponding space for other purposes outside these specific flight situations. The solution according to the invention is based on the knowledge that, in typical passenger aircraft, a sanitary module is located directly next to the entry region of the aircraft door, optionally an outer wall of the sanitary module being adjacent to the entry region, and a door for entry to the sanitary module leading into an aisle of the aircraft, which is arranged substantially perpendicularly to the entry region. Often, such a configuration or a similar configuration is selected so that the sanitary module can be used by the passengers via the aisle during flight, without those passengers having to enter the entry region and a region which is often adjacent thereto for the aircrew which optionally comprises a rest area and/or a galley, etc. The entry region or aircrew region is, in fact, often separated from the passenger cabin during the flight by a curtain or a partition. However, the assist space is usually only required in flight situations in which the sanitary module cannot and/or must not be used. This fact, together with the above-described geometric arrangement of the aircraft entry region, is made use of by the present invention.

Accordingly, in the present case, an assist space can be created by simply moving a portion of the outer wall of the sanitary module which is adjacent to the entry region into the inner space of the sanitary module. By means of the folding in or out of the folding alcove according to the invention, an assist space can be provided quickly and simply at any time. This, thus, has the considerable advantage that this space is otherwise fully available, namely, as an inner space of the sanitary module. At the same time, however, in specific flight situations, additional space can be created which the aircrew can enter in order, for example, to assist the passengers in the region of the aircraft door.

According to one development, the folding connections can each comprise one or more folding walls. The folding walls can be connected to one another and/or to the side wall and/or to the alcove wall. In this development, a folding connection can be designed having a certain similarity to a folding door. The folding connection can comprise a plurality of folding walls which are fixed together one behind the other, a folding wall at the end being connected to a vertical longitudinal edge of the side wall, and a corresponding folding wall at the end being connected to a longitudinal edge of the alcove wall. A person skilled in the art will directly derive herefrom an array of similar or alternative solutions for designing the folding connection. For example, the folding connection can be designed similarly to the bellows of an accordion comprising a plurality of folded faces or walls.

According to one development, the folding walls can be connected by means of vertical hinged joints. Alternatively, hinges, hinged joints, or other solutions which are known to a person skilled in the art from other technical fields, can also be used in this case. In principle, solutions without hinged connections are also conceivable, for example, in which the folding connection comprises a single wall or layer having a plurality of folds.

According to one development, the folding walls can also be designed to be flexible. Accordingly, the walls can comprise, for example, a thin, smooth and flexible plastics material or the like. In principle, however, the walls can also be constructed, for example, from a textile-like material.

According to one development, the alcove wall, in the folded-in state of the folding alcove, can end flush with the side wall. In this development, the alcove wall blends into the outer wall of the sanitary module in an inconspicuous and practically “invisible” mariner so that it is visually pleasing.

In one development, the folding alcove can be dimensioned in such a way that the alcove can accommodate a standing person fully, or at least to a large extent, in the folded-out state of the folding alcove. The assist space, which is formed by means of the folding alcove, accordingly provides enough space that a flight attendant can easily find enough room to help the passengers enter or exit the aircraft. For example, the alcove created can have a width in the range of from 40 cm to 60 cm, e.g., 50 cm (which, in turn, can correspond to the width of the alcove wall), and a depth in the range of, for example, 10 cm to 40 cm, e.g., 15 cm or 30 cm.

According to one development, the sanitary module can further comprise a lock. The lock can be designed to fix the folding alcove in the folded-out state and/or the folded-in state. This development has the advantage that the folding alcove is folded in or out only when required, and as a result, is fixed in such a way that the alcove can be moved again only by operating the lock once more. In this development, for example, passengers can be prevented from operating the folding alcove without authorization. Such a lock can be implemented, for example, by means of one or more bolts which can be operated mechanically or electronically.

According to one development, the lock can be operated from outside the sanitary module. In principle, it would be conceivable, for example, for the lock to be able to be operated by means of the cabin management system. Alternatively, for example, a bolt, lever or the like can be provided in the region of the alcove wall outside the sanitary module in the region of the aircraft door.

According to one development, the alcove wall can be in the form of sandwich panels and/or can be constructed from sandwich panels. For example, the alcove wall can be a thin casing wall or casing panels or the like.

According to one development, the folding alcove can be directly adjacent to the aircraft door. This is advantageous in that the relevant flight attendant can occupy an ideal position in order to come to the aid of a passenger in the region of the entry door.

According to one development, the aircraft door region can further comprise a second aircraft door which is opposite the first aircraft door inside the aircraft. The aircraft door region can further comprise a second entry region which is adjacent to the second aircraft door. The aircraft door region can further comprise a galley which is adjacent to the second entry region and is formed having an operating region which is opposite the sanitary module. The first aircraft door can be positioned on the right in the direction of flight of the aircraft, and the second aircraft door can be positioned on the left in the direction of flight. This development opens up further advantageous possibilities of creating additional space inside an aircraft door region by arranging a sanitary module comprising a folding alcove in conjunction with a galley in a particularly advantageous manner

The aircraft door region can further comprise a cockpit door which is designed to be opened between the sanitary module and the galley. The cockpit door can be designed having an aircrew seat which can be folded out.

The configurations and developments above can be combined with one another as desired where appropriate. Further possible configurations, developments and implementations of the invention go beyond the explicitly mentioned combinations of features of the invention described previously or in the following with respect to the particular embodiments shown and described. In particular, in the process, a person skilled in the art will also add individual aspects as improvements or additions to the respective basic form of the present invention.

### BRIEF DESCRIPTION OF THE DRAWINGS

The present invention will be described in greater detail below on the basis of the embodiments shown in the schematic drawings, in which:

FIGS. 1a and 1b are schematic plan views of an aircraft door region comprising an aircraft door and comprising a sanitary module having a folding alcove according to one embodiment of the invention, the folding alcove being in a folded-in state in FIG. 1a and in a folded-out state in FIG. 1b.

FIG. 2 shows schematic plan views of the folding alcove from FIGS. 1a and 1b in various folding states;

FIG. 3 is a schematic side view of an aircraft comprising the aircraft door from FIG. 1a and 1b; and

FIG. 4 is a schematic plan view of an aircraft door region comprising two aircraft doors and a sanitary module having a folding alcove according to another embodiment of the invention.

The accompanying figures are intended to provide further understanding of the embodiments of the invention. They illustrate embodiments and are used, in conjunction with the description, to explain principles and concepts of the invention. Other embodiments and many of the above-mentioned advantages can be found in the drawings. The elements of the drawings are not necessarily shown to scale with respect to one another.

In the figures of the drawings, elements, features and components which are like, functionally like or have the same effect—unless otherwise specified—are each provided with the same reference numerals.

### DETAILED DESCRIPTION OF THE PREFERRED EMBODIMENTS

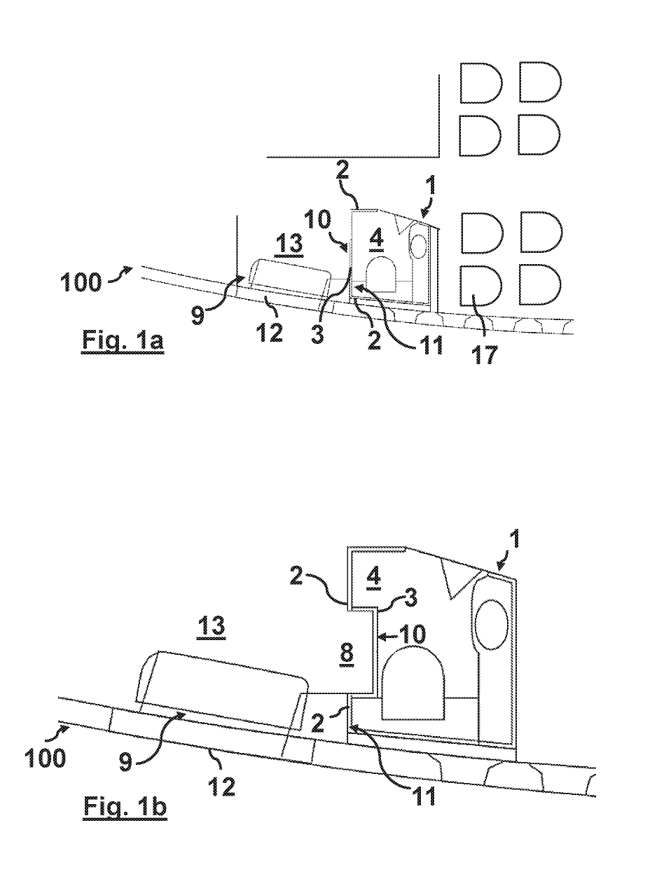

FIGS. 1a and 1b are schematic plan views of an aircraft door region comprising an aircraft door and comprising a sanitary module having a folding alcove according to one embodiment of the invention. In FIG. 1a, the folding alcove is in a folded-in state, and in FIG. 1b, in a folded-out state. In this case, FIG. 1b shows an enlarged detail of FIG. 1a.

In FIG. 1a, the reference numeral 100 denotes an aircraft, for example a passenger aircraft. The aircraft 100 comprises an aircraft door region 9 having an aircraft door 12, to which an entry region 13 is adjacent inside the aircraft 100. For example, FIG. 3 is a schematic side view of such an aircraft 100 comprising the aircraft door 12 from FIGS. 1a and 1b. Directly adjacent to the entry region 13 and the aircraft door 12, there is a sanitary module 1, an outer wall 11 of the sanitary module 1 forming a side wall of the entry region 13. A region for the aircrew (no reference numeral) is joined to the left of the entry region 13, and to the right of the entry region 13, a central aisle (likewise no reference numeral) leads from the entry region 13 approximately at a right angle to the passenger seats (no reference numeral). The sanitary module 1 comprises an inner space 4, which can be equipped for example with a toilet, a shower, a washstand, etc.

The outer wall 11 of the sanitary module 1 is divided into a side wall 2 and an alcove wall 3. In this case, the side wall 2 forms a stationary vertical portion of the outer wall 11, whereas the alcove wall 3 forms a movable vertical portion of the outer wall 11. In particular, the alcove wall 3 is designed to be movable in such a way that it can be moved into the inner space 4 of the sanitary module 1. For example, the alcove wall 3 can be designed in such a way that it can be moved into the inner space 4 by a person standing in the entry region 13 simply pressing with their hands. Alternatively, or additionally, other mechanical and/or electronic solutions are also provided. Thus, for example, a lever can be provided, or an electronic switching device, by means of which a movement of the alcove wall 3 into the inner space 4 can be triggered.

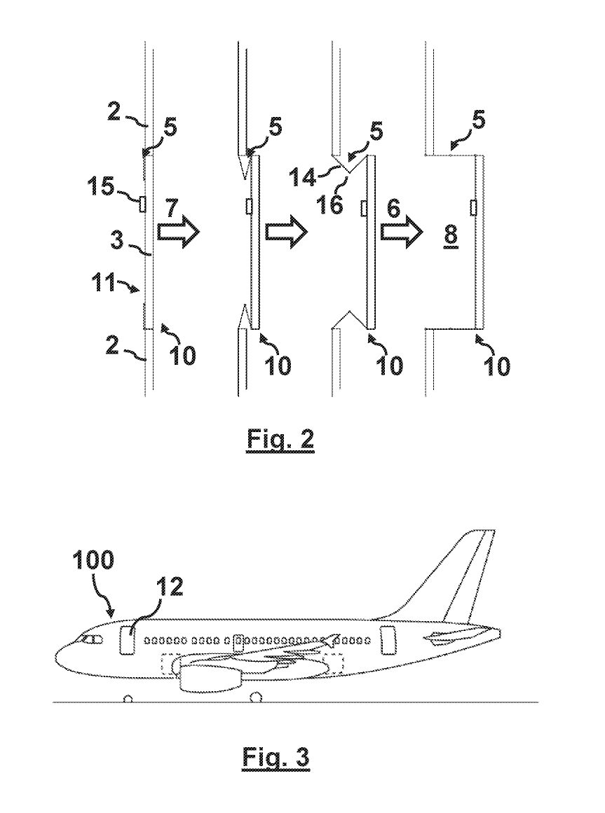

In principle, the alcove wall 3 forms part of a folding alcove 10, which is explained in detail below with reference to FIG. 2. The alcove wall 3 can be moved into the inner space 4 of the sanitary module 1 to create a folded-out state of the folding alcove 10 so that an alcove 8 is created in the outer wall 11 of the sanitary module 1. FIG. 1a shows a folded-in state of the folding alcove 10, in which the alcove wall 3 is in contact with the side wall 2, and ends substantially flush with the side wall 2. FIG. 1b shows a folded-out state of the folding alcove 10, in which the alcove wall 3 has been moved into the inner space 4 of the sanitary module 1. The outer wall 11 of the sanitary module 1 comprises an alcove 8 in this case. The alcove 8 can be used, for example, as an assist space or the like in order to allow the aircrew to assist passengers entering or exiting through the aircraft door in specific flight situations (for example during entry or exit or in the event of emergency evacuations). For this purpose, the flight attendants can fold the folding alcove 10 into the inner space 4 of the sanitary module 1 and enter the alcove 8. Optionally, it can be provided that the flight attendants check the inner space 4 of the sanitary module 1 beforehand and/or lock it to prevent it from being used. This can be carried out, for example, directly by the flight attendants by means of a visual inspection. In principle, however, semi or fully automated solutions are also provided in which a cabin management system or the like indicates whether the sanitary module 1 is occupied or not, and the folding alcove 10 is locked or released on this basis; for example, for this purpose, a mechanical or electronic lock 15 can be provided for the folding alcove 10. In particularly simple solutions, the folding alcove 10 can be designed to be simply operated by hand Alternatively, or additionally, however, solutions are also provided in which the folding alcove 10 can be triggered electronically, for example by means of the cabin management system. In all other flight situations in which the assist space is not required, the folding alcove 10 can be folded in so that the sanitary module 1 can be used without any restrictions, i.e. in particular the inner space 4 is fully available for the sanitary module 1.

A person skilled in the art will derive various solutions as to how the folding alcove 10 is closed at the floor or ceiling of the aircraft 100 or the passenger cabin or the sanitary module 1. Thus for example it can be provided that the lock 15 is designed to fix the folding alcove 10, i.e., the alcove wall 3 and/or the folding connections 5, in the folded-out state and/or the folded-in state in a floor of the aircraft 100 or the sanitary module 1. For example, guide rails or grooves or the like can be provided in which the components of the folding alcove 10 can move along the ceiling at the top and along the floor at the bottom of the aircraft 100 (or the passenger cabin or the sanitary module 1) and/or in which the components can be engaged.

FIG. 2 shows schematic plan views of the folding alcove 10 from FIGS. 1a and 1b in various folding states.

As explained above, the outer wall 11 of the sanitary module 1 is divided into a stationary side wall 2 and a movable alcove wall 3. The alcove wall 3 together with two folding connections 5 forms a folding alcove 10. The folding connections 5 each connect a vertical longitudinal edge of the alcove wall 3 to a vertical longitudinal edge of the side wall 2. The folding connections 5 can be folded out into the inner space 4 of the sanitary module 1. For this purpose, each folding connection 5 comprises two folding walls 14, which are interconnected in each case. One of the folding walls 14 is additionally connected to the side wall 2 in each case, whereas the other folding wall 14 is coupled to the alcove wall 3 in each case. The folding walls 14 are interconnected by means of vertical hinged joints 16 or the like. The alcove wall 3 can thus be moved into the inner space 4 of the sanitary module 1 to create a folded-out state 6 of the folding alcove 10, the folding connections 5 being folded out into the inner space 4 and, as a result, an alcove 8 being created in the outer wall 11 of the sanitary module 1. The sequence of a folding-out process is indicated by arrows from left to right in FIG. 2. Starting from a folded-in state 7 of the folding alcove 10, in which the alcove wall 3 is in contact with the side wall 2, and the folding connections 5 are folded in, the alcove wall 3 can be moved into the inner space 4 of the sanitary module 1 until a completely folded-out state 6 of the folding alcove 10 is created, in which the folding connections 5 are folded out to the maximum extent, and the alcove wall 3 is moved into the inner space 4 to the maximum extent. The design shown of the folding alcove 10, and, in particular, the configuration of the folding connections 5, is shown merely by way of example, and a person skilled in the art will accordingly derive solutions which have the same effect in an obvious manner. For example, the folding connections 5 can comprise a greater or smaller number of folding walls 14. Alternatively, a different mechanism for creating a folding connection 5 can additionally be selected which allows the folding alcove 10 to be folded into the inner space 4 in a corresponding manner

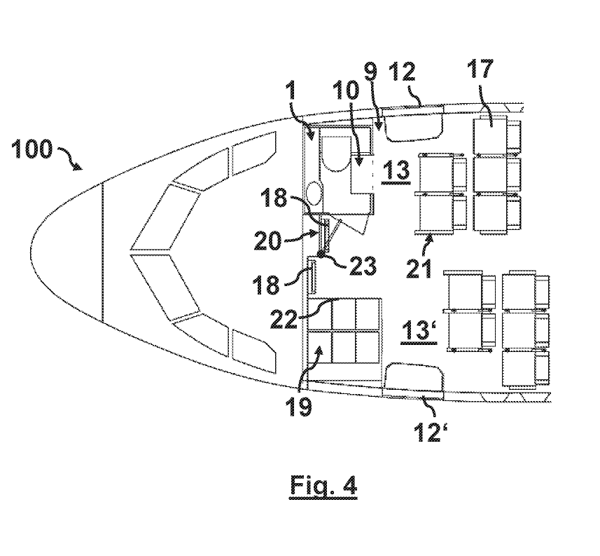

FIG. 4 is a schematic plan view of an aircraft door region 9 comprising two aircraft doors 12, 12′ and a sanitary module 1 having a folding alcove 10 according to another embodiment of the invention.

The aircraft door region 9 shown in FIG. 4 is located in a front cabin region of a passenger aircraft 100 comprising an aisle (e.g., a standard-body aircraft or a narrow-body aircraft). The aircraft door region 9 comprises a first aircraft door 12 on the right-hand side of the passenger aircraft 100 in the direction of flight and a second aircraft door 12′ on the left-hand side in the direction of flight. A first entry region 13 and a second entry region 13′ respectively is adjacent to the respective aircraft door 12, 12′ inside the passenger aircraft 100.

Adjacent to the first entry region 13 and the first aircraft door 12, there is a sanitary module 1, which comprises a door for entry to the aisle of the aircraft 100. In this case, the sanitary module 1 can have a similar design to that in FIGS. 1a and 1b. Similarly to in FIGS. 1a and 1b, an outer wall 11 of the sanitary module 1 forms a side wall of the first entry region 13. Analogously to the sanitary module 1 from FIGS. 1a and 1b, this sanitary module 1 is also formed in particular having a folding alcove 10 which is adjacent to the entry region 13 and thus can be used to optionally create an assist space for using the first aircraft door 12.

Adjacent to the second entry region 13′ and the second aircraft door 12′, there is a galley 19, the operating region 23 of which is formed opposite the door for entry to the sanitary module 1 along the aisle of the aircraft 100. This basic arrangement of the aircraft door region 9 according to the embodiment in FIG. 4 is thus virtually a mirror image of conventional arrangements of aircraft door regions of passenger aircraft having an aisle. In conventional configurations, a sanitary module is located on the left-hand side in the direction of flight, whereas the galley is correspondingly located on the right-hand side. The operating region of such galleys is also frequently rotated by 90° with respect to that in FIG. 4, i.e., the galley in conventional single-aisle arrangements can be operated from the region transversely to the aisle (corresponding to the first entry region 13 in FIG. 4). The new type of arrangement based on the present invention which is shown in FIG. 4 provides a considerable gain in space inside the aircraft door region 9 with respect to this conventional aircraft door region. The operating region 23 of the galley 19 can thus be operated from the aisle so that the first entry region 13 can be designed to be considerably narrower than in conventional arrangements in which the galley is used from this region. Aircrew seats 18 can, for example, be attached at the top of the aisle in such a way that they can be folded out, as shown in FIG. 4. For this purpose, FIG. 4 shows by way of example an aircrew seat 18 which is attached to the wall of the top of the aisle, and an aircrew seat 18 which is attached to a cockpit door 20 in such a way that it can be folded out. The cockpit door 20 can be designed, for example, in such a way that it can be opened into the aisle between the sanitary module 1 and the galley 19, for example, a corresponding door hinge 22 can be coupled to the cockpit door 20 on the left-hand side (indicated in FIG. 4). The space gained thereby inside the aircraft door region 9 opens up the possibility of accommodating an additional row of seats 21 comprising, for example, 2 passenger seats in the passenger cabin (foremost row of seats 21 in FIG. 4). In the second entry region 13′ of the second aircraft door 12′, for example, a gap in a row of seats can provide an assist space (at the bottom in FIG. 4).

In the description detailed above, various features for improving the conclusiveness of the description are summarized in one or more examples. However, it should be clear in this case that the description above is of a merely illustrative and in no way restrictive nature. It is intended to cover all alternatives, modifications and equivalents of the various features and embodiments. Many other examples will immediately be clear to a person skilled in the art in view of the above description due to their specialist knowledge.

The embodiments have been selected and described in order to optimally represent the principles forming the basis of the invention and the possible applications thereof in practice. As a result, persons skilled in the art can optimally modify and use the invention and the various embodiments thereof with respect to the intended purpose thereof In the claims and the description, the terms “containing” and “including” are used as neutral terminology for the corresponding term “comprising”. Furthermore, use of the terms “a” and “one” should not in principle exclude a plurality of features and components described in this way.

In the foregoing detailed description, various features are grouped together in one or more examples or examples with the purpose of streamlining the disclosure. It is to be understood that the above description is intended to be illustrative, and not restrictive. It is intended to cover all alternatives, modifications and equivalents. Many other examples will be apparent to one skilled in the art upon reviewing the above specification.

The embodiments were chosen and described in order to best explain the principles of the invention and its practical applications, to thereby enable others skilled in the art to best utilize the invention and various embodiments with various modifications as are suited to the particular use contemplated. In the appended claims and throughout the specification, the terms “including” and “in which” are used as the plain-English equivalents of the respective terms “comprising” and “wherein,” respectively. Furthermore, “a” or “one” does not exclude a plurality in the present case.

1. A sanitary module for an aircraft, comprising:
a side wall forming a stationary vertical portion of an outer wall of the sanitary module; and
a folding alcove; comprising:
an alcove wall forming a movable vertical portion of the outer wall of the sanitary module which is configured to be moved into an inner space of the sanitary module; and
two folding connections, which each connect a vertical longitudinal edge of the alcove wall to a vertical longitudinal edge of the side wall and form the folding alcove together with the alcove wall;
wherein the folding connections are configured to be folded out into the inner space of the sanitary module so that the alcove wall can be moved into the inner space of the sanitary module to create a folded-out state of the folding alcove in such a way that an alcove is formed in the outer wall of the sanitary module by the alcove wall and the folding connections; and
wherein the folding connections are configured to be folded in to create a folded-in state of the folding alcove in such a way that the alcove wall is in contact with the side wall.

2. The sanitary module according to claim 1, wherein the folding connections each comprise one or more folding walls which are connected to at least one of one another, the side wall and the alcove wall.

3. The sanitary module according to claim 2, wherein the folding walls are connected by means of vertical hinged joints.

4. the sanitary module according to claim 2, wherein the folding walls are flexible.

5. The sanitary module according to claim 1, wherein the alcove wall, in the folded-in state of the folding alcove, ends flush with the side wall.

6. The sanitary module according to claim 1, wherein the folding alcove is dimensioned in such that the alcove accommodates a standing person at least to a large extent, in the folded-out state of the folding alcove.

7. The sanitary module according to claim 1, further comprising a lock which fixes the folding alcove in at least one of the folded-out state or the folded-in state.

8. The sanitary module according to claim 7, wherein the lock is operable from outside the sanitary module.

9. The sanitary module according to claim 1, wherein the alcove wall is at least one of
in the form of sandwich panels, and
constructed from sandwich panels.

10. An aircraft door region of an aircraft, comprising:
a first aircraft door;
a first entry region adjacent to the first aircraft door; and
a sanitary module, comprising:
a side wall forming a stationary vertical portion of an outer wall of the sanitary module; and
a folding alcove; comprising:
an alcove wall forming a movable vertical portion of the outer wall of the sanitary module which is configured to be moved into an inner space of the sanitary module; and
two folding connections, which each connect a vertical longitudinal edge of the alcove wall to a vertical longitudinal edge of the side wall and form the folding alcove together with the alcove wall;
wherein the folding connections are configured to be folded out into the inner space of the sanitary module so that the alcove wall can be moved into the inner space of the sanitary module to create a folded-out state of the folding alcove in such a way that an alcove is formed in the outer wall of the sanitary module by the alcove wall and the folding connections; and
wherein the folding connections are configured to be folded in to create a folded-in state of the folding alcove in such a way that the alcove wall is in contact with the side wall,
the outer wall of the sanitary module being adjacent to the first entry region;
wherein the folding alcove of the sanitary module is formed in a portion of the outer wall of the sanitary module which faces the first entry region.

11. The aircraft door region according to claim 10, wherein the folding alcove is directly adjacent to the first aircraft door.

12. The aircraft door region according to claim 10, further comprising:
a second aircraft door opposite the first aircraft door inside the aircraft;
a second entry region adjacent to the second aircraft door; and
a galley adjacent to the second entry region and being formed having an operating region opposite the sanitary module;
wherein the first aircraft door is positioned on the right in the direction of flight of the aircraft, and the second aircraft door is positioned on the left in the direction of flight.

13. The aircraft door region according to claim 12, further comprising a cockpit door configured to be opened between the sanitary module and the galley, wherein the cockpit door is formed having an aircrew seat configured to be folded out.

14. An aircraft comprising an aircraft door region, comprising:
a first aircraft door;
a first entry region adjacent to the first aircraft door; and
a sanitary module, comprising:
a side wall forming a stationary vertical portion of an outer wall of the sanitary module; and
a folding alcove; comprising:
an alcove wall forming a movable vertical portion of the outer wall of the sanitary module which is configured to be moved into an inner space of the sanitary module; and
two folding connections, which each connect a vertical longitudinal edge of the alcove wall to a vertical longitudinal edge of the side wall and form the folding alcove together with the alcove wall;
wherein the folding connections are configured to be folded out into the inner space of the sanitary module so that the alcove wall can be moved into the inner space of the sanitary module to create a folded-out state of the folding alcove in such a way that an alcove is formed in the outer wall of the sanitary module by the alcove wall and the folding connections; and
wherein the folding connections are configured to be folded in to create a folded-in state of the folding alcove in such a way that the alcove wall is in contact with the side wall,
the outer wall of the sanitary module being adjacent to the first entry region;
wherein the folding alcove of the sanitary module is formed in a portion of the outer wall of the sanitary module which faces the first entry region.
